(19) United States
(12) Patent Application Publication
(10) Pub. No.: US 2023/0298464 A1
(43) Pub. Date: Sep. 21, 2023

(54) Systems and Methods for Distributed Video-Management in Traffic Monitoring Systems

(71) Applicant: Rekor Systems, Inc., Columbia, MD (US)

(72) Inventor: Christopher Allen KADOCH, Leesburg, VA (US)

(21) Appl. No.: 18/184,576

(22) Filed: Mar. 15, 2023

Related U.S. Application Data
(60) Provisional application No. 63/320,616, filed on Mar. 16, 2022.

(51) Int. Cl. G08G 1/04; G06V 20/54; G08G 1/127

(52) U.S. Cl. CPC G08G 1/04; G06V 20/54; G08G 1/127; G06V 2201/08

(57) ABSTRACT

A traffic monitoring system includes a remote monitoring system that hosts a video management platform via which a user reviews video data; and one or more traffic sensors communicatively coupled to the remote monitoring system via a wireless network. At least one traffic sensor of the one or more traffic sensors includes a controller that generates low-bit video data and corresponding high-bit video data, and a transceiver that: (a) initially transmits the low-bit video data exclusive of the high-bit video data to the remote monitoring system, and (b) subsequently and in response to a request for the corresponding high-bit video data received from the remote monitoring system, transmits the high-bit video data to the remote monitoring system.

### CROSS REFERENCE TO RELATED APPLICATION

This application claims priority to Provisional Application No. 63/320,616, filed Mar. 16, 2022, the entire contents of which are hereby expressly incorporated by reference herein.

### BACKGROUND OF THE INVENTION

The present invention relates to traffic monitoring systems and methods, and more particularly to such systems and methods distributed video management.

Traffic monitoring systems generally include traffic cameras that capture video clips of passing traffic—e.g., roadway traffic—for playback review by law enforcement or other interested users. The playback review of the captured video clips is generally done via a video-management system.

At the same time, the data intensity of the video clips continues to increase, particularly where additional backend processing is desired. For example, the successful application of facial recognition to the video clip necessitates a higher data intensity. The current approach to satisfying this need is to simply transmit all video clips at increasingly higher data intensities.

Historically, however, less than 0.5% of the all the collected video data is ever reviewed. Thus, as the video data becomes increasingly data intensive—for example, where rich media is being generated—so does the data transmission to the system server become increasingly costly and inefficient.

It is therefore desirable to provide a traffic monitoring system that reduces the operational load on the communications infrastructure while making this data intensive video data available as needed to the video-management system.

### BRIEF SUMMARY OF THE INVENTION

Systems and methods are disclosed for a traffic monitoring system that reduces the operational load on the communications infrastructure while making high-bit video data available as needed to the video-management system.

In at least one embodiment, the traffic monitoring system includes a traffic sensor and a server system remote therefrom. The traffic sensor can have a controller that generates both low-bit video data and high-bit video data. The traffic sensor can also have a transceiver that initially transmits the low-bit video data to the remote server system for review by a user via a video-management platform. The user can, via the video-management platform, review the low-bit video data and request the corresponding high-bit video data from the traffic sensor. The high-bit video data can be transmitted, in response to the request, to the server system by the traffic sensor. The user can thereafter, via the video-management platform, review the high-bit video data. The operational load on the communications infrastructure can accordingly be reduced without restricting the availability of the high-bit video data to the video-management platform.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

### BRIEF DESCRIPTION OF THE DRAWINGS

The features, objects, and advantages of the present invention will become more apparent from the detailed description, set forth below, when taken in conjunction with the drawings, in which like reference characters identify elements correspondingly throughout.

FIG. 1 illustrates an exemplary system in accordance with at least one embodiment of the invention.

FIG. 2 illustrates an exemplary method in accordance with at least one embodiment of the invention.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

The present invention generally relates to traffic monitoring systems and methods, and more particularly to such systems and methods for reducing the operational load on the communications infrastructure of the system while retaining the ability to provide high-bit video data on an as-needed basis for use by the video-management platform.

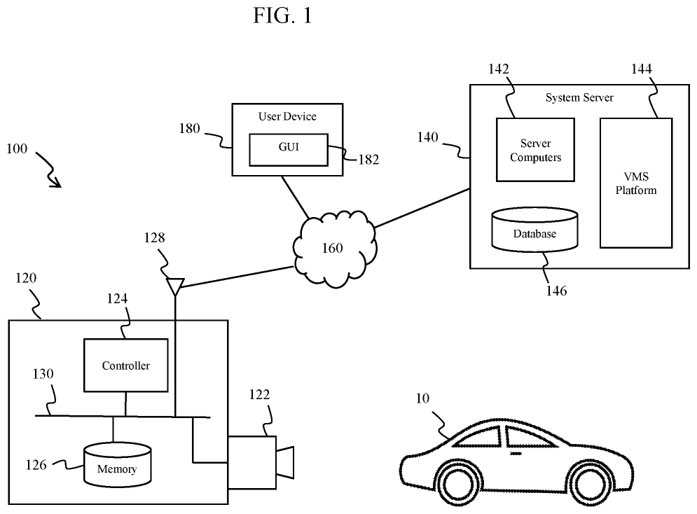

FIG. 1 is a schematic representation of a traffic monitoring system 100 in accordance with one or more aspects of the invention. As shown in FIG. 1, the traffic monitoring system 100 comprises one or more traffic sensors 120 communicatively coupled to a system server 140, via a network 160. The system server may also be communicatively coupled to one or more user devices 180 via the network. The traffic monitoring system 100 generally enables the collection of traffic related data for transmission, via the network, to the system server 140. The traffic monitoring system 100 also generally enables user access to the traffic related data stored on the system server 140, via the coupled user devices 180.

The traffic sensors 120 may comprise an imaging device 122, a controller 124, a memory 126, and a transceiver 128, each communicatively coupled to a common data bus 130 that enables data communication between the respective components.

The imaging device 122 may capture images of traffic, in particular, video images of vehicles 10 making up the traffic, and generates video data therefrom. The imaging device 122 may be a video camera of any camera type, which captures video images suitable for computerized image recognition of objects within the captured images. For example, the camera may utilize charge-coupled-device (CCD), complementary metal-oxide-semiconductor (CMOS) and/or other imaging technology, to capture standard, night-vision, infrared, and/or other types of images, having predetermined resolution, contrast, color depth, and/or other image characteristics. The video data may be timestamped so as to indicate the date and time of recording. The video data may further include other identifying information, including geolocation data and/or traffic sensor ID data.

The controller 124 may include image processing software for applying image processing to the video data captured by the imaging device 122 so as to generate processed video data. Some exemplary types of image processing that may be applied to the video data include image enhancement, encoding, compression, and recognition processing. The image processing may result in the generation of processed video data that includes, for example, low-bit video data and corresponding high-bit video data. The low-bit video data may have an image resolution and/or other characteristics such that the low-bit video data is lower in bit-size than the corresponding high-bit video data of the same scene. Moreover, each of the low-bit video data and the high-bit video data may be associated with the same identifier (e.g., timestamp, geolocation data, sensor ID data, etc.), such that the identifier of the low-bit video data may be used to identify the corresponding high-bit video data via matching identifiers.

In some embodiments, the image processing results in the generation of the low-bit video data, where the originally captured video data is the high-bit video data. In further embodiments, the image processing results in the generation of the high-bit video data, where the originally captured video data is the low-bit video data. In still further embodiments, the image processing results in the generation of both the high-bit and the low-bit video data, where neither is the originally captured video data.

In operation, the low-bit video data may be initially transmitted to the system server 140 in lieu of the high-bit video data. The high-bit video data may then be later transmitted to the system server 140 in response to a request for the high-bit video data, which may be received by the controller 124 from the system server 140 in response to the transmission of the low-bit video data. The controller 124 of the appropriate traffic sensor 120 may accordingly identify and retrieve the requested high-bit video data from its memory 126.

The request may be a global request sent to each traffic sensor 120, or a targeted request sent to one or more specific traffic sensors 120. Accordingly, the request may include at least one identifier, which identifies the requested high-bit video data sufficient for the appropriate traffic sensor 120 to retrieve the requested high-bit video data from its memory 126. The identifier may include, for example, one or more of: timestamp data, a geolocation data, and a sensor ID. The timestamp data may include a timestamp range of the high-bit video data, so as to define a temporal range of high-bit video data requested. The geolocation and/or sensor ID data may be sufficient to identify the appropriate traffic sensor 120 from which to retrieve the high-bit video data.

The controller 124 may be embodied, collectively or individually, as one or more processors programmed to carry out the functions of the unit in accordance software stored in the memory 126. Each processor may be a standard processor, such as a central processing unit (CPU), or a dedicated processor, such as an application-specific integrated circuit (ASIC) or field programmable gate array (FPGA), or portion thereof.

The memory 126 stores software and data that can be accessed by the processor(s), and includes both transient and persistent storage. The transient storage is configured to temporarily store data being processed or otherwise acted on by other components, and may include a data cache, RAM or other transient storage types. The persistent storage is configured to store software and data until deleted. The memory 126 is accordingly configured to store the data and information described herein. In particular, the memory 126 stores the video data therein, including the low-bit video data and its corresponding high-bit video data.

The transceiver communicatively couples the traffic sensor 120 to the network so as to enable data transmission therewith. The network may be any type of network, wired or wireless, configured to facilitate the communication and transmission of data, instructions, etc., and may include a local area network (LAN) (e.g., Ethernet or other IEEE 802.03 LAN technologies), Wi-Fi (e.g., IEEE 802.11 standards, wide area network (WAN), virtual private network (VPN), global area network (GAN)), a cellular network, or any other type of network or combination thereof.

The system server 140 may include one or more server computers 142 connected to the network. Each server computer may include computer components, including one or more processors, memories, displays and interfaces, and may also include software instructions and data for executing the functions of the server described herein. The servers may also include one or more storage devices configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc., configured so that the server computers 142 may access it. The storage components may also support one or more databases for the storage of data therein.

The system server 140 is generally configured to provide centralized support for the traffic sensors 120. The system server 140 is configured to receive video data (and other data) from each of the traffic sensors 120, and to store the video data for users to access via the user devices 180. The system server 140 may therefore include one or more databases configured to store the video data received from the traffic sensors 120, including low-bit video data and high-bit video data.

The system server 140 may include one or more video-management software applications, stored in the memory, which software applications, when executed by the processor configures the server computer to host and/or otherwise support a video-management platform 144. The video-management platform 144 may be an online platform (e.g., a website) or a local platform (e.g., a closed computer network).

The video-management platform 144 may be generally configured to permit users, via the user devices 180, to interact with video data stored by the system server 140. In particular, the video-management platform 144 may support a graphical user interface 182 that permits users to select and retrieve video data for video playback via the user device 180. In some embodiments, the video playback may be substantially up to real-time, or live-stream, video playback.

The graphical user interface 182 may also enable one or more playback functions, including but not limited to permitting users to pause, rewind and fast-forward the video playback. The graphical user interface 182 may further permit other interactions, which may include, for example, object recognition (e.g., license plate recognition, vehicle recognition, etc.), object tagging, video frame notations, data analytics, hit list comparison, and/or smart search capabilities.

In at least one embodiment, the video-management platform 144 further permits users to request from the traffic sensors 120 high-bit video data corresponding to identified low-bit video data. The system server 140 may be configured to transmit the request to the appropriate traffic sensor 120. In response, the traffic sensor 120 may retrieve the requested high-bit video data from the memory, and transmit it to the server system for storage and use by the video-management platform 144.

In operation, the user may review a low-bit video playback corresponding to low-bit video data stored in the database. The low-bit video playback may be sufficient for the user to identify one or more portions of the video playback where further review as a high-bit video playback is desired. The user may request the corresponding high-bit video data from the appropriate traffic sensor 120, which upon receipt by the video-management system may be reviewed as the high-bit video playback.

The user devices 180 are generally computing devices, and may include mobile (e.g., laptop computer, tablet computer, smartphone, PDA, wearable, etc.) or stationary (e.g., desktop computer, etc.), multi-purpose or dedicated, devices configured to communicate data and information with the system server 140. The user devices 180 may include components typically associated with such devices, such as one or more processors, physical memories, software instructions, data, displays, and interfaces. The user devices 180 may further include one or more software applications, stored in memory, which software applications, when executed by the processor, configures the user devices 180 to function as described herein. In particular, the user devices 180 are configured to allow the users to interact with the video-management platform 144, as described herein.

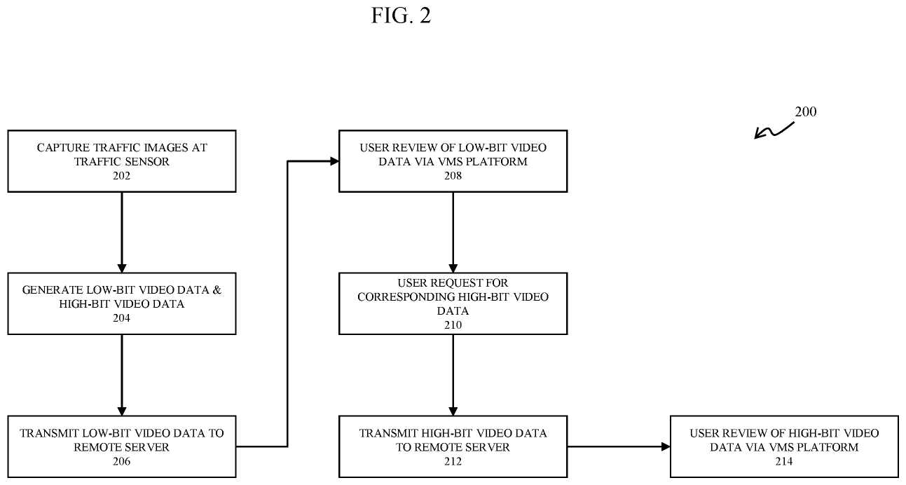

FIG. 2 is a flow-chart that represents an exemplary method 200 of operation for the traffic monitoring system 100 in accordance with one or more aspects of the invention.

In operation, at step 202, respective imaging devices 122 of a plurality of traffic sensors 120 capture images of vehicle traffic, namely, video images of passing vehicles, and generate video data therefrom. The traffic sensors 120 are preferably each positioned at various roadway locations where the vehicle traffic is to be monitored. The imaging devices 122 are preferably positioned such that the captured images include the respective license plates of the passing vehicles, as well as other vehicle characteristics, e.g., vehicle type, class, make, model, color, year, drive type, license plate number, registration, trajectory, speed, location, etc., or any combination thereof.

At step 204, the controller 124 of each respective imaging device 122 processes the video data captured by that imaging device 122 so as to generate the low-bit video data and the high-bit video data. The controller 124 may utilize any image processing software suitable for this purpose. At least the high-bit video data is retrievably stored in the memory until deletion.

At step 206, the traffic sensor 120 transmits the low-bit video data to the system server 140. The low-bit video data may have image resolution and/or other characteristics such that the low-bit video data is lower in bit-size than the corresponding high-bit video data of the same scene. Such transmitting of the low-bit video data may include transmitting one or more identifiers (e.g., timestamp data, geolocation data, traffic sensor ID, etc.). In at least one embodiment, the low-bit video data is automatically transmitted, i.e., is “pushed,” to the system server 140.

At step 208, the user accesses the video-management platform 144 of the server system so as to review, via the graphical user interface 182, the low-bit video playback of the low-bit video data. Such access may be via one or more of the user devices 180 over the network connection. The graphical user interface 182 may enable playback functions, including but not limited to permitting users to pause, rewind and fast-forward the video playback, so as to enable the user to identify one or more portions of the low-bit video data for which further review of the captured images via the high-bit playback is desired.

At step 210, the user requests high-bit video data corresponding to the portions of the low-bit video playback for which further high-bit review is desired. The request may include the identifier of the corresponding low-bit video data, which also corresponds to the identifier of the corresponding high-bit video data to be reviewed. Accordingly, the request is transmitted to the appropriate traffic sensor 120 from which to retrieve the appropriate high-bit video data, at step 212.

At step 214, the traffic sensor 120 may retrieve the requested high-bit video data from the memory, and transmit it to the server system for storage and use by the video-management platform 144. In particular, the high-bit video data may be accessed for high-bit video playback via the video-management platform 144.

In this manner, the operational load on the communications infrastructure of the traffic monitoring system 100 is reduced, while retaining the ability to provide high-bit video data on an as-needed basis for the video-management platform 144.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the described embodiments and equivalents thereof.

What is claimed is:

1. A traffic monitoring system, comprising:
a remote monitoring system that hosts a video management platform via which a user reviews video data; and
one or more traffic sensors communicatively coupled to the remote monitoring system via a wireless network, wherein a traffic sensor of the one or more traffic sensors comprises:
a controller that generates low-bit video data and corresponding high-bit video data, and
a transceiver that:
(a) initially transmits the low-bit video data exclusive of the high-bit video data to the remote monitoring system, and
(b) subsequently and in response to a request for the corresponding high-bit video data received from the remote monitoring system, transmits the high-bit video data to the remote monitoring system.

2. The traffic monitoring system of claim 1, wherein the remote monitoring system is configured such that the user can cause the request to be transmitted to the traffic sensor via the video management platform in response to reviewing the low-bit video data.

3. The traffic monitoring system of claim 1, wherein the request comprises a global request that is transmitted to each of the one or more traffic sensors.

4. The traffic monitoring system of claim 1, wherein the request comprises a targeted request sent only to the traffic sensor.

5. The traffic monitoring system of claim 1, wherein the request identifies the corresponding high-bit video data sufficient for controller to identify and retrieve the corresponding high-bit video data from an on-sensor memory where it is stored.

6. The traffic monitoring system of claim 1, wherein both the low-bit video data and the high-bit video data are generated so as to include at least one of: a timestamp, a geolocation, and a sensor identification.

7. The traffic monitoring system of claim 1, wherein the low-bit video data is not suitable for automated image recognition, and the corresponding high-bit video data is suitable for automated image recognition.

8. The traffic monitoring system of claim 1, wherein the low-bit video data is generated via image processing of original video data captured by the traffic sensor, and the corresponding high-bit video data is the original video data.

9. The traffic monitoring system of claim 1, wherein both the low-bit video data and the corresponding high-bit video data are generated via image processing of original video data captured by the traffic sensor.

10. The traffic monitoring system of claim 1, wherein the traffic sensor is a video camera that captures video images of surrounding traffic.

11. A traffic monitoring method, comprising:
hosting, by a remote monitoring system, a video management platform via which a user reviews video data;
communicatively coupling one or more traffic sensors to the remote monitoring system via a wireless network;
generating, by a traffic sensor of the one or more traffic sensors, low-bit video data and corresponding high-bit video data;
initially transmitting the low-bit video data exclusive of the high-bit video data to the remote monitoring system from the traffic sensor;
transmitting a request for the corresponding high-bit video data by the user via the video management platform;
receiving at the traffic sensor the request; and
transmitting, in response to the request, the corresponding high-bit video data to the remote monitoring system from the traffic sensor.

12. The method of claim 11, wherein the request is transmitted to the traffic sensor by the remote monitoring system in response to the user reviewing the low-bit video data via the video management platform.

13. The method of claim 11, wherein the request comprises a global request that is transmitted to each of the one or more traffic sensors.

14. The method of claim 11, wherein the request comprises a targeted request sent only to the traffic sensor.

15. The method of claim 11, wherein the request identifies the corresponding high-bit video data sufficient for controller to identify and retrieve the corresponding high-bit video data from an on-sensor memory where it is stored.

16. The method of claim 11, wherein both the low-bit video data and the high-bit video data are generated so as to include at least one of: a timestamp, a geolocation, and a sensor identification.

17. The method of claim 11, wherein the low-bit video data is not suitable for automated image recognition, and the corresponding high-bit video data is suitable for automated image recognition.

18. The method of claim 11, wherein the low-bit video data is generated via image processing of original video data captured by the traffic sensor, and the corresponding high-bit video data is the original video data.

19. The method of claim 11, wherein both the low-bit video data and the corresponding high-bit video data are generated via image processing of original video data captured by the traffic sensor.

20. The method of claim 11, wherein the traffic sensor is a video camera that captures video images of surrounding traffic.
